(19) United States
(12) Patent Application Publication
(10) Pub. No.: US 2008/0149008 A1
(43) Pub. Date: Jun. 26, 2008

(54) Apparatus for improved security

(76) Inventor: Michael Hall, Santa Cruz, CA (US)

Correspondence Address: WAGNER, MURABITO & HAO LLP, Third Floor, Two North Market Street, San Jose, CA, 95113, US

(21) Appl. No.: 11/643,056

(22) Filed: Dec. 20, 2006

(51) Int. Cl. E05G 1/04

(52) U.S. Cl. 109/51

(57) ABSTRACT

An apparatus, device and enclosure for securing objects. Embodiments provide an apparatus, device and enclosure for securing objects in workspace drawers, where the apparatus may be mounted in a portion of a drawer to secure some objects while maintaining convenient access to other unsecured items in the same drawer. The apparatus has one or more engagement features which protrude from its body or housing to engage an interior surface of the drawer. The engagement features may disengage the drawer for removal of the apparatus only when it is placed in an unsecured state (e.g., when it is able to receive objects to be secured), thereby preventing unauthorized removal of the apparatus from the drawer. As such, the apparatus provides a convenient and effective means for securing objects by limiting access to secured items while still maintaining functionality of the drawer and access to unsecured items.

### BACKGROUND OF THE INVENTION

As technology continues to advance, the need for improved security is also increasing. For example, where money was once the most valuable item carried by people, the average person now carries around portable electronics with a combined value that far exceeds the amount of money carried in the wallet. As such, these valuable items are prime targets for theft when left unattended, for example at a desk or workstation, and should be secured. However, convenient and effective security measures around desks, workstations and/or offices can be improved.

For example, although locking desk drawers are somewhat common, they have proven to be both inconvenient and ineffective. For example, since accessible drawer space at a given workstation is limited, items which are less valuable and often more commonly-used are placed in the same drawer with more valuable items. As such, when the drawer is locked to secure the more valuable items, access to the commonly-used items is also restricted. Accordingly, locking valuable items becomes burdensome given the number of times that the drawer must be locked and unlocked to keep the items secure and provide access to other commonly-used items in the drawer. And further, given the increased frequency of locking and unlocking the drawer, the probability of a person forgetting to lock the drawer increases, thereby subjecting valuable items to an increased chance of theft. Thus, locking drawers may be inconvenient, which may make them ineffective given that people either choose not to use them or forget to lock them.

Similarly, many workstations allow a set of drawers (e.g., a column of vertically-stacked drawers) to be locked simultaneously with a single key. The problems discussed above with respect to a single drawer are therefore exacerbated as access to even more commonly-used items is restricted. Thus, an average workstation provides inconvenient means for securing valuable items, which in turn renders the security measures ineffective through lack of use as discussed above.

### SUMMARY OF THE INVENTION

Accordingly, a need exists for a more convenient and effective means of securing items. A need also exists for a workspace storage device which may be placed in a secured state while still allowing ready access to commonly-used items left in an unsecured state. Embodiments of the present invention provide novel solutions to these needs and others as described below.

Embodiments of the present invention are directed to an apparatus, device and enclosure for securing objects. More specifically, embodiments provide an apparatus, device and enclosure for securing objects in workspace drawers, where the apparatus may be mounted in a portion of a drawer to secure some objects while maintaining convenient access to other unsecured items in the same drawer. For example, the apparatus may be mounted in a file drawer to accept both small and large items such that files in the drawer may still be accessed. The apparatus has one or more engagement features which protrude from its body or housing to engage an interior surface of the drawer. The engagement features may disengage the drawer for removal of the apparatus only when it is placed in an unsecured state (e.g., when it is able to receive objects to be secured), thereby preventing unauthorized removal of the apparatus from the drawer. As such, the apparatus provides a convenient and effective means for securing objects by limiting access to secured items while still maintaining functionality of the drawer and access to unsecured items.

In one embodiment, an apparatus for securing objects includes a housing for storage of the objects, where the housing is sized for mounting within a drawer and having an opening for receiving the objects. A lock mechanism is operable to limit access to said objects within the housing. The apparatus also includes at least one member coupled to the housing and for reducing movement of the housing with respect to the drawer when the housing is interposed in the drawer. And in one embodiment, the apparatus also includes a door coupled with the housing and for closing the opening, wherein the lock mechanism is operable to secure the door to the housing such that the access to the objects is limited.

In another embodiment, a device for securing items in a file drawer includes a receptacle for storing the items. A member is operable to couple with the receptacle and limit access to the items when placed in a secured state. A lock mechanism is coupled to the member and for placing the member in a secured state. The device also includes a plurality of engagement features coupled to the receptacle for physically engaging the file drawer when the receptacle is placed within the file drawer. The device may also include the above and wherein the member comprises a door which is rotatably coupled to the receptacle by a hinge mechanism. Additionally, the device may also include the above and wherein at least one of the plurality of engagement features is adjustable to enable disengagement from the file drawer and removal of the receptacle from the file drawer when the member is in an unsecured state.

And in yet another embodiment, an apparatus for securing objects in a drawer includes a housing for storage of the objects. A lock mechanism is operable to place the housing in a secured state, wherein access to the objects within the housing is limited when maintained in the secured state. The apparatus also includes at least one engagement feature coupled to the housing and for securing the housing to the drawer when the housing is interposed in the drawer. The apparatus may also include a door coupled with the housing, wherein the door is operable to close an opening of the housing to limit access to the objects when in the secured state.

And in yet another embodiment, a safe includes a housing shaped to fit within the confines of a desk drawer, where the housing includes an opening for receipt and storage of items within the housing. A door coupled to the housing is operable to close the opening to restrict access to items within the housing when in a closed state. The safe also includes a lock for locking the door when in the closed state. Additionally, a plurality of adjustable elements are mounted on at least two sides of the housing, the elements for physically contacting interior sides of the drawer for securing the housing within the drawer.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary security device in accordance with one embodiment of the present invention.

FIG. 2 shows a perspective view of an exemplary security device in an exemplary mounting location in accordance with one embodiment of the present invention.

FIG. 3 shows a top view of an exemplary security device in an exemplary mounting location in accordance with one embodiment of the present invention.

FIG. 4 shows a second exemplary security device in accordance with one embodiment of the present invention.

FIG. 5 shows a third exemplary security device in accordance with one embodiment of the present invention.

FIG. 6 shows the third exemplary security device with an object organizer in accordance with one embodiment of the present invention.

FIG. 7 shows a fourth exemplary security device in an unsecured state in accordance with one embodiment of the present invention.

FIG. 8 shows the fourth exemplary security device in a secured state in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

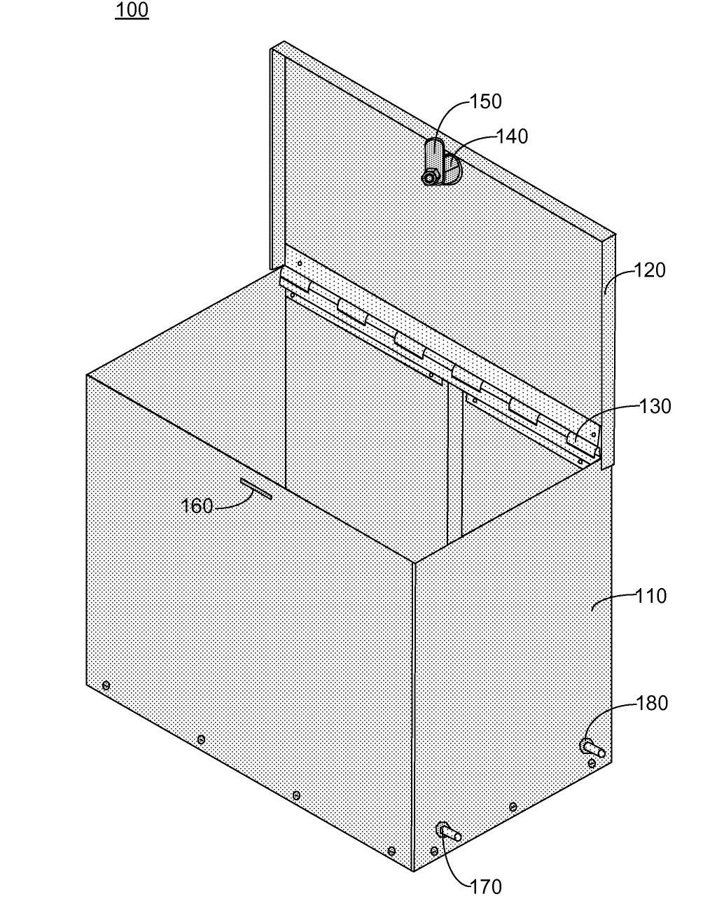

FIG. 1 shows exemplary security device 100 in accordance with one embodiment of the present invention. As shown in FIG. 1, security device 100 comprises housing 110 for securing objects placed therein. Door 120 is rotatably coupled with housing 110 via hinge mechanism 130 such that door 120 may be closed to limit access to objects placed inside security device 120. The objects placed inside device 100 may comprise, but are not limited to, electronic devices, wallets, purses, computer-readable medium comprising music/movies, documents, password lists and/or other items for which security is sought.

After closing door 120, security device 100 may be placed in a secured state by adjusting the state of lock mechanism 140 (e.g., by turning a key, etc.) such that lock arm 150 (shown coupled to lock mechanism 140) engages locking feature 160 (shown as part of housing 110 in FIG. 1). Once security device 100 is placed in a secured state, access to objects placed with device 100 is limited by door 120. To return device 100 to an unsecured state and enable access to objects placed therein, the state of lock mechanism 140 may be alternatively adjusted (e.g., so that lock arm 150 no longer engages locking feature 160) and door 120 may be opened.

Lock mechanism 140 may comprise any locking technology enabling a user to toggle between one or more security states (e.g., corresponding to privilege levels) using a user interface and/or user control associated with the locking mechanism. For example, the locking mechanism may be mechanical (e.g., key-actuated, combination, etc.), electrical (e.g., voice activated, etc.), optical (e.g., fingerprint activated, use eye-related recognition, etc.), etc.

Hinge mechanism 130 may comprise a separate mechanism for attachment to housing 110 and door 120 in one embodiment. In another embodiment, hinge mechanism may be formed as part of housing 110, door 120, or both. Additionally, although hinge mechanism 130 is depicted in FIG. 1 in a specific mounting location with respect to housing 110 and door 120, it should be appreciated that door 120 may hinge from other locations in other embodiments.

Although FIG. 1 depicts the use of lock arm 150 and locking feature 160, it should be appreciated that alternative engagement features may be used in other embodiments. For example, door 120 may engage housing 110 using two tabs, a hook and eyelet, a hook and tab, or the like. Further, instead of coupling directly to lock mechanism 140, the engagement features may be coupled with lock mechanism 140 in other embodiments.

Additionally, although FIG. 1 depicts door 120 rotatably coupled with housing 110 via hinge mechanism 130, it should be appreciated that door 120 may alternatively couple to housing 110 in other embodiments. For example, door 120 may be not be coupled to or with (e.g., able to be completely removed from) housing 110 when device 100 is in an unsecured state, whereas door 120 may then be coupled to or with housing 120 when placed in a secure state. Alternatively, a variety of alternative attachment mechanisms (e.g., tabs and corresponding slots, etc.) may be used in place of hinge mechanism 130.

Further, whereas the engagement of lock arm 150 and locking feature 160 hold door 120 shut in a secured state, it should be appreciated that latching and locking functions may be allocated to different mechanisms in other embodiments. For example, latches or other hold-down features may be used to hold door 120 shut in other embodiments, where lock mechanism may control the secured/unsecured states by preventing door 120 from being opened once latched (e.g., by preventing the door from opening as depicted in FIG. 1 with the use of features that engage, by preventing the latch mechanism from being actuated to unlatch door 120 from housing 110, etc.).

Although FIG. 1 depicts device 100 in the shape of a rectangular box, it should be appreciated that device 100 may assume other shapes in other embodiments. Additionally, although FIG. 1 depicts device 100 with a given size, it should be appreciated that device 100 may assume other sizes in other embodiments.

Additionally, device 100 may be formed from a variety of materials to provide varying costs, levels of security, and design choices. For example, device 100 may be formed from sheet metal. Alternatively, an impact resistant plastic (e.g., polycarbonate, acrylonitrile butadiene styrene, a PC/ABS combination, etc.) may be used. Moreover, the material may be colored (e.g., by the use of colored material, colored coating, etc.), where such color scheme may coordinate and/or match that of another component, device, room, etc. For example, device 100 may be colored to coordinate and/or match the color scheme of a computer system at a workstation utilizing device 100, the color scheme of an office utilizing device 100, etc.

As shown in FIG. 1, security device 100 comprises engagement features 170 and 180 for mounting and/or securing device 100 in a desk drawer, cabinet, enclosure or other desired mounting location. After placing device 100 in the desired mounting location (e.g., a drawer), engagement features 170 and 180 may be extended to engage a wall of the drawer. Engagement features similar to 170 and 180 may be used on one or more other sides of housing 110, for example, to engage an inside wall of the drawer opposing the wall engaged by features 170 and 180. The amount by which the engagement features (e.g., 170, 180, etc.) extend may be varied either manually (e.g., by turning a threaded portion of the features which engages threads in housing 110, etc.) or automatically (e.g., using spring-loaded engagement features, piston-actuated engagement features, etc.). As such, device 100 may be secured to the desired mounting location by engaging the engagement features (e.g., 170, 180, etc.) with one or more mounting surfaces of the mounting location. In one embodiment, the engagement features may be pointed or tipped to better grab a mounting surface (e.g., an interior wall of a drawer made from wood, metal, etc.) and facilitate securing device 100 within the mounting location.

To reduce unauthorized tampering with the mounting of security device 100, engagement features (e.g., 170, 180, etc.) used in device 100 may be adjusted from the inside of housing 110. As such, once device 100 is mounted and placed in secured state (e.g., by actuating lock mechanism 140), the ability to adjust the engagement features from the outside (e.g., by an unauthorized user without the ability to actuate lock mechanism 140 and open door 120) is restricted. Thus, placing device 100 in a secure state serves not only to secure items placed within device 100 from theft, but also to secure items to the mounting location (e.g., a drawer of an office desk, etc.) in which device 100 is mounted or fastened.

Although FIG. 1 depicts a specific number of engagement features (e.g., 170, 180, etc.), it should be appreciated that a larger or smaller number of engagement features may be used in other embodiments. Additionally, the engagement features (e.g., 170, 180, etc.) may be alternatively placed (e.g., in different locations on the same wall of housing 110, on different walls of housing 110, etc.) in other embodiments (e.g., to allow device 100 to be alternatively rotated and mounted within a mounting location, etc.). Further, it should be appreciated that device 100 may comprise a combination of adjustable and fixed engagement features, where the adjustable engagement features may be used to engage the fixed engagement features by pressing the fixed engagement features against a respective wall.

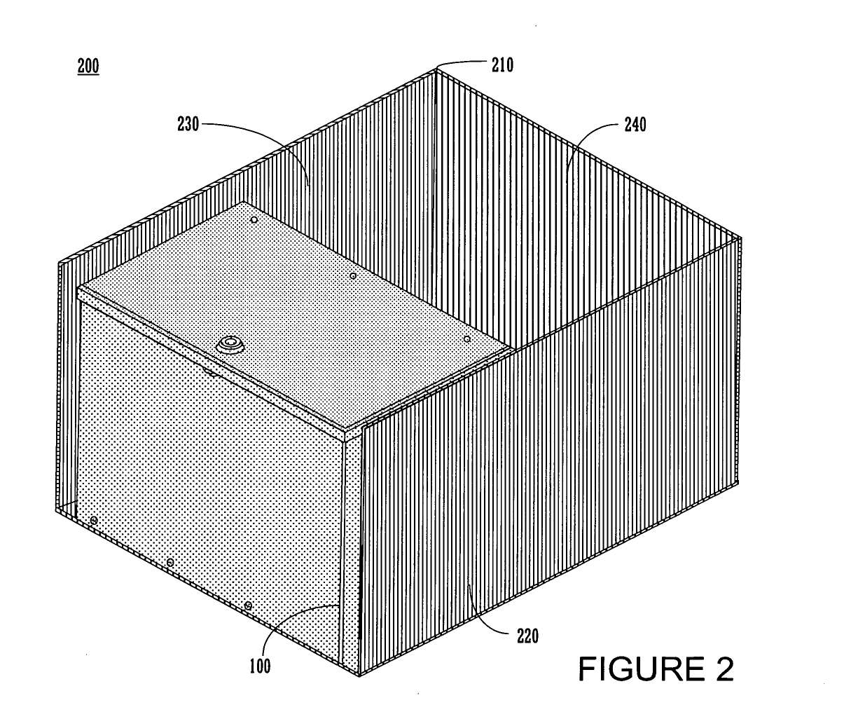

FIG. 2 shows perspective view 200 of exemplary security device 100 in an exemplary mounting location in accordance with one embodiment of the present invention. As shown in FIG. 2, exemplary mounting location 210 comprises side walls 220 and 230, as well as back wall 240. In one embodiment, mounting location 210 may comprise a portion of a workstation drawer (e.g., a file drawer, smaller utility drawer, etc.), where walls 220-240 represent portions of the drawer walls. As such, security device 100 may be positioned within the walls (e.g., 220-240) of mounting location 210 such that engagement features (e.g., 170, 180, etc. of FIG. 1) may protrude from the device housing (e.g., 110 of FIG. 1) to mount device 100 by engaging a respective wall of mounting location 210.

Additionally, by varying the position of device 100 within mounting location 210, the space available for unsecured items (e.g., between device 100 and back wall 240, on the front side of device 100 opposite back wall 240, etc.) may be varied and/or redistributed (e.g., on either side of device 100). For example, where mounting location 210 comprises a file drawer, files may be placed on either or both sides of security device 100. As such, in addition to securing objects, security device 100 may also act as a file divider when placed in a file drawer. In one embodiment, hanging files may be located in front of, behind or on both sides of device 100.

Although FIG. 2 shows security device 100 at a certain distance from side walls 220 and 230, it should be appreciated that the distance between security device 100 and a respective wall may be varied (e.g., by adjusting the amount of protrusion of the engagement features on each side of device 100). In one embodiment, reducing the distance between device 100 and an engaged wall (e.g., 220, 230, etc.) may improve security by reducing unauthorized manipulation of the engagement features once device 100 is placed in a secured state. It is appreciated that the width of device 100 may be selected such that it fits within the widths of most workstation drawers (e.g., those that accommodate hanging files). Additionally, various sizes may be provided to accommodate other widths (e.g., standard, legal, etc.).

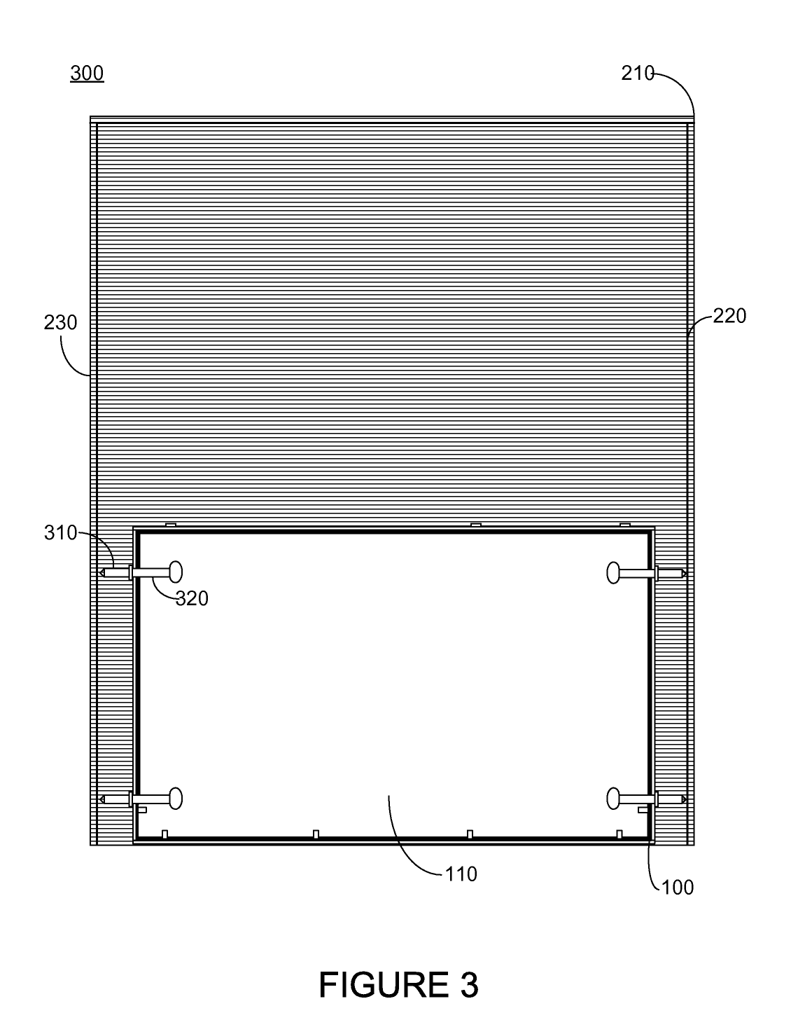

FIG. 3 shows top view 300 of exemplary security device 100 in exemplary mounting location 210 in accordance with one embodiment of the present invention. As shown in FIG. 3, engagement features (e.g., 170, 180, etc. of FIG. 1) may comprise an engagement portion 310 for physically engaging a respective mounting location surface (e.g., side wall 220, 230, etc.). Additionally, adjustable engagement features may also comprise an adjustment portion 320 for enabling manual and/or automatic adjustment of the protrusion distance of the engagement features from device 100. For example, adjustment portion 320 may comprise screw threads which mesh with threads in the device housing (e.g., 110 of FIG. 1), where a rotation of adjustment portion 320 (e.g., using a respective knob) may advance or retract engagement portion 310. Additionally, a engagement locking feature (not shown in FIG. 3) may be used to lock the engagement features (e.g., 170, 180, etc. of FIG. 1) in position, where the engagement locking feature may comprise a nut (e.g., hex nut, wing nut, or the like to enable double-nut locking), kingpin mechanism, or the like. Alternatively, adjustment portion 320 may couple to or with a component (not shown in FIG. 3) for automatically advancing and/or retracting engagement portion 310, where the component may comprise a spring, piston, or the like.

Given that adjustment portion 320 is only accessible from inside device 100 as shown in FIG. 3, unauthorized manipulation of the engagement features is restricted once access to the inside of device 100 is limited (e.g., when device 100 is placed in a secured state). Thus, insertion and removal of device 100 from mounting location 210 is limited to authorized users, as is placement of device 100 within mounting location 210 (e.g., to vary and/or redistribute unsecured object area 330).

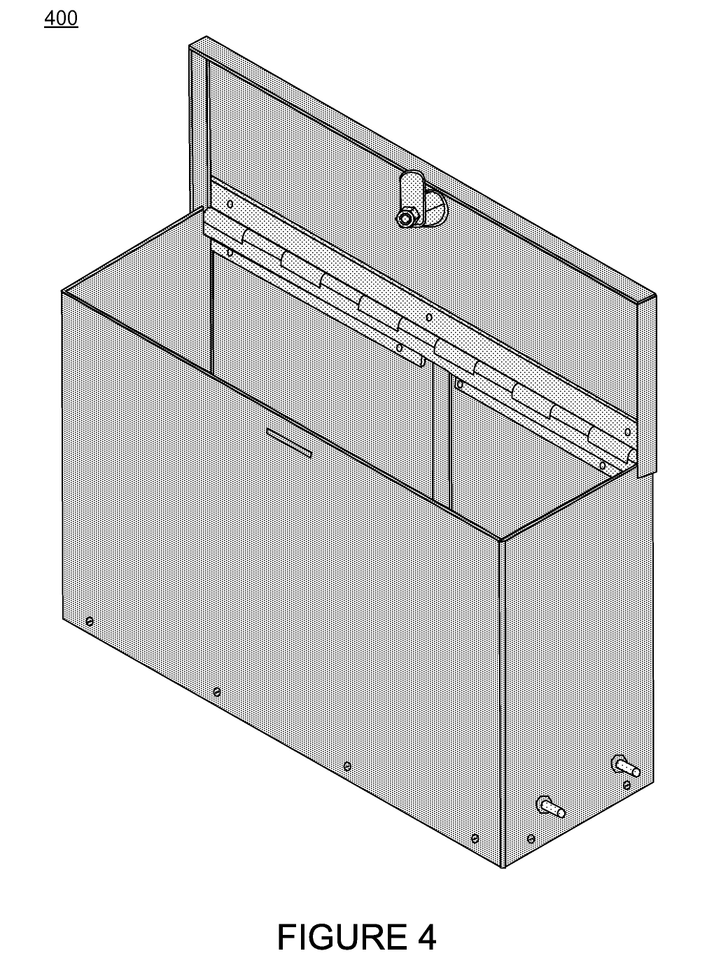

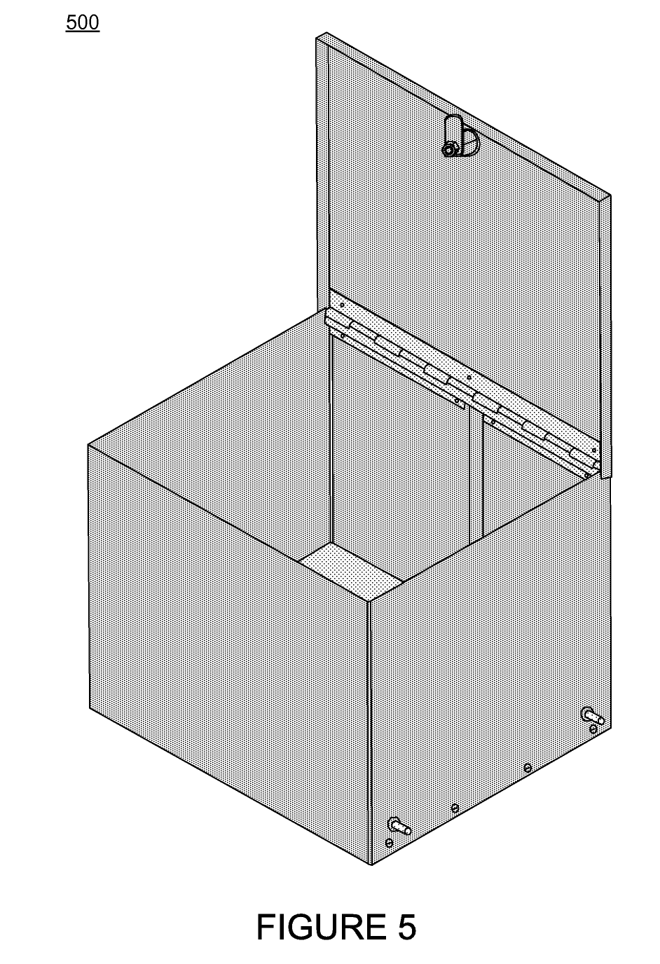

FIGS. 4 and 5 show second exemplary security device 400 and third exemplary security device 500 in accordance with embodiments of the present invention. Devices 400 and 500 operate analogously to device 100 as described above with respect to previous figures. However, devices 400 and 500 are sized differently from device 100.

For example, the depth of device 400 as shown in FIG. 4 is less than the depth of device 100 as shown in FIG. 1. As such, device 400 offers more drawer space for unsecured objects (e.g., unsecured object area 330 of FIG. 3). Conversely, the depth of device 500 as shown in FIG. 5 is greater than the depth of device 100 as shown in FIG. 1. As such, device 500 offers more space for secured objects placed inside device 500.

Although FIGS. 4 and 5 depict devices 400 and 500 in the shape of a rectangular box, it should be appreciated that devices 400 and 500 may assume other shapes in other embodiments. Additionally, although FIGS. 4 and 5 depict devices 400 and 500 with a given size, it should be appreciated that devices 400 and 500 may assume other sizes (e.g., other standard drawer sizes) in other embodiments.

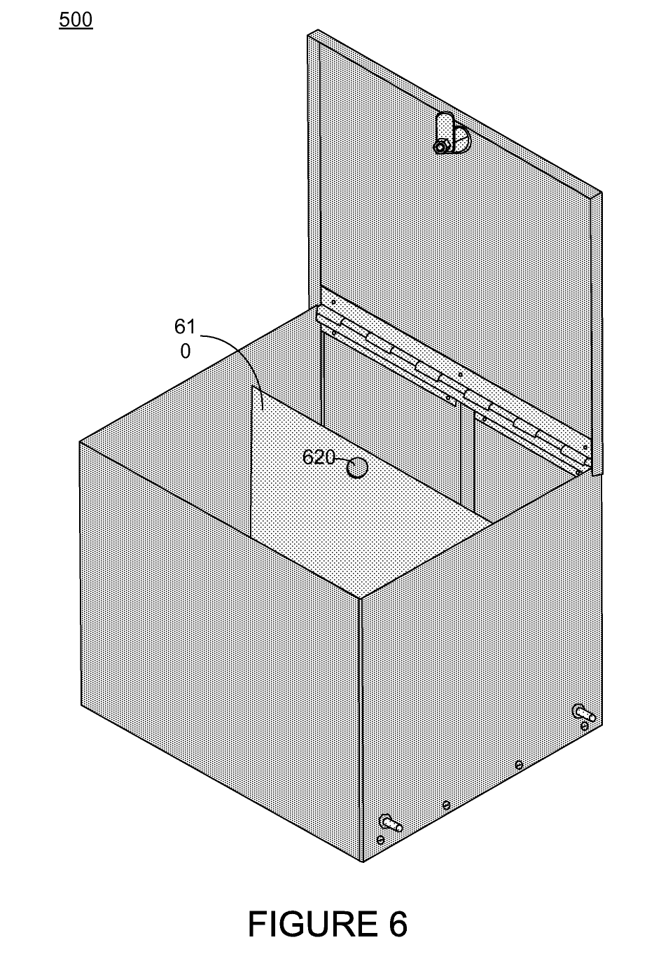

FIG. 6 shows third exemplary security device 500 with an object organizer in accordance with one embodiment of the present invention. As shown in FIG. 6, object organizer 610 may be placed in security device 500 to help organize objects to be secured. For example, organizer 610 may partition the interior of the security device (e.g., 500) into two or more storage compartments. And in another embodiment, organizer 610 may form a shelf to organize objects placed within the security device. As such, it should be appreciated that one or more types of organizing features may be used to organize objects (e.g., shelves, dividers, etc.), where one or more of each type may be used. Further, it should be appreciated that an organizer (e.g., 610) may be used in the security devices discussed above (e.g., 100 and 400).

To make removal and/or readjustment of organizer 610 more convenient, optional handle feature 620 is provided. As depicted in FIG. 6, handle feature 620 may comprise a cutout in organizer 610. Alternatively, handle feature 620 may comprise an additional member (e.g., a handle, knob, etc.) coupled to organizer 610.

And in another embodiment, security device 500

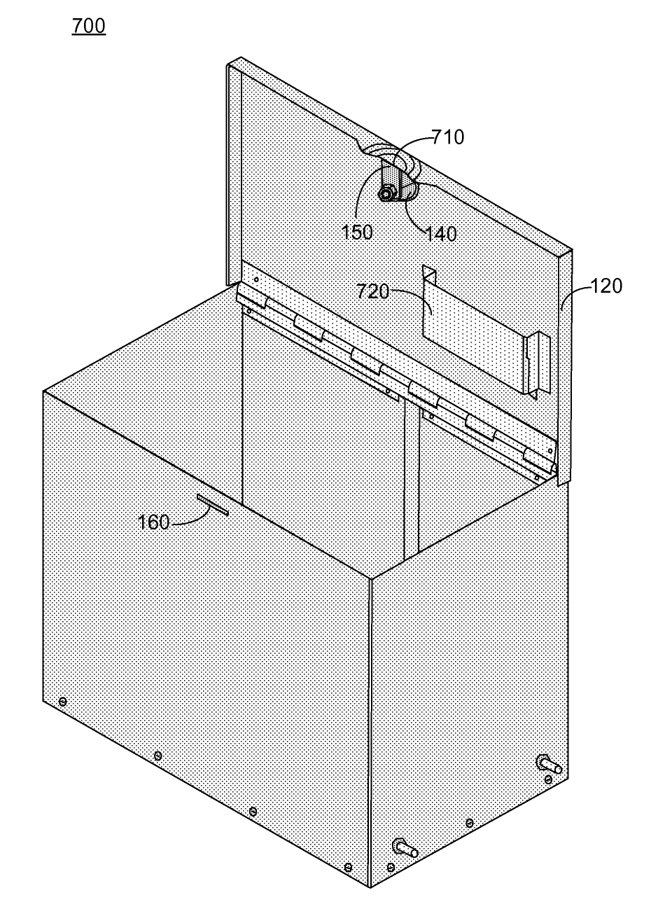

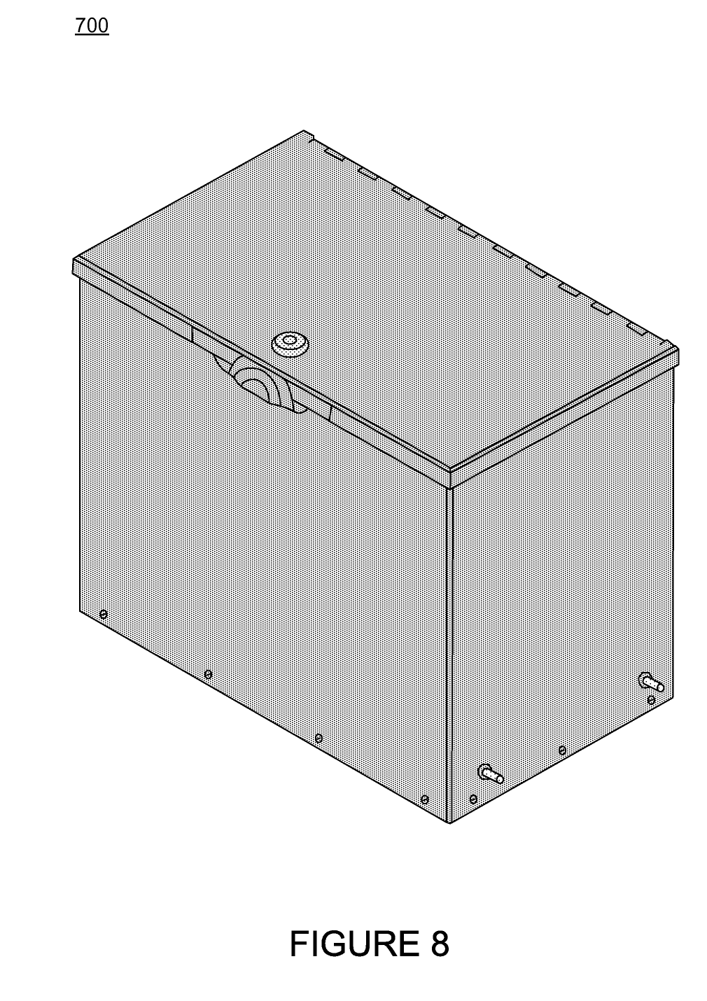

FIGS. 7 and 8 show fourth exemplary security device 700 in an unsecured state and a secured state, respectively, in accordance with one embodiment of the present invention. Security device 700 operates analogously to device 100, except for the inclusion of additional features. For example, device 700 comprises anti-tampering feature 710 and pouch 720.

Anti-tampering feature 710 is coupled to door 120 in front of lock arm 150 such that it limits access to lock arm 150 and locking feature 160 when door 120 is closed (e.g., as shown in FIG. 8). As such, tampering with device 700, and more specifically the locking components (e.g., 140, 150 and 160) of device 100, is limited. Thus, feature 710 increases the security of items secured within device 700.

As shown in FIG. 7, pouch 720 is coupled to door 120 to provide additional object storage and organization options. For example, pouch 720 may be used to store more commonly-used items (e.g., a portable storage device, a portable media device, a wallet, a password list, etc.) for which security is sought, where it may be desirable to separate the time from other items (e.g., a purse, documents, etc.) secured in device 710. Additionally, in one embodiment, pouch 720 may comprise a lid or covering to help contain items within pouch 720.

Although feature 710 and pouch 720 may be coupled to door 120, it should be appreciated that feature 710 and/or pouch 720 may be formed into door 120 in other embodiments. It should also be appreciated that features such as feature 710, pouch 720, etc. may be coupled to or formed as part of device 700 in other embodiments. Additionally, although feature 710 and pouch 720 are depicted with a certain shape, size and location, it should be appreciated that other shapes, sizes and locations may be used for feature 710 and/or pouch 720. Further, it should be appreciated that other features (e.g., a clip for holding password lists, hooks for hanging jewelry, etc.) may be coupled to device 700 in addition to or in place of feature 710 and/or pouch 720.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

1. An apparatus for securing objects, said apparatus comprising:
a housing for storage of said objects, said housing sized for mounting within a drawer and having an opening for receiving said objects, said housing further for enabling placement of additional objects in said drawer and outside of said housing while said housing is mounted in said drawer;
a lock mechanism for limiting access to said objects within said housing; and
at least one member coupled to said housing and for reducing movement of said housing with respect to said drawer when said housing is interposed in said drawer.

2. The apparatus of claim 1 further comprising:
a door coupled with said housing and for closing said opening; and
wherein said lock mechanism is operable to secure said door to said housing such that said access to said objects is limited.

3. The apparatus of claim 2, wherein said door is rotatably coupled to said housing by a hinge mechanism.

4. The apparatus of claim 1, wherein said movement is reduced by an engagement of said at least one member with an interior surface of said drawer, and wherein said at least one member protrudes from said housing to enable said engagement with said interior surface of said drawer.

5. The apparatus of claim 1, wherein said at least one member is adjustable to enable removal of said housing from said drawer when in an unsecured state.

6. The apparatus of claim 4, wherein said at least one member comprises screw threads, and wherein a rotation of a portion of said at least one member is operable to adjust an amount by which said at least one member protrudes from said housing.

7. The apparatus of claim 4, wherein said at least one member comprises at least one spring for pressing said at least one member against said interior surface of said drawer to provide said engagement.

8. The apparatus of claim 1, wherein said drawer is a file drawer.

9. The apparatus of claim 8, wherein said housing forms a divider for files in said file drawer.

10. The apparatus of claim 1 further comprising at least one object organizer for organizing said objects within said housing.

11. A device for securing items in a file drawer, said device comprising:
a receptacle for storing said items, said receptacle further for enabling placement of additional objects in said file drawer and outside of said receptacle while said receptacle is mounted in said file drawer;
a member for coupling with said receptacle and for limiting access to said items when placed in a secured state;
a lock mechanism coupled to said member and for placing said member in a secured state; and
a plurality of engagement features coupled to said receptacle for physically engaging said file drawer when said receptacle is placed within said file drawer.

12. The device of claim 11, wherein said member comprises a door, and wherein said door is rotatably coupled to said receptacle by a hinge mechanism.

13. The device of claim 11, wherein at least one of said plurality of engagement features is adjustable to enable disengagement from said file drawer and removal of said receptacle from said file drawer when said member is in an unsecured state.

14. The device of claim 11, wherein said plurality of engagement features comprise screw threads, and wherein a rotation of a portion of a select engagement feature is operable to adjust an amount by which said select engagement feature protrudes from said body receptacle to engage said file drawer.

15. The device of claim 11, wherein at least one of said plurality of engagement features comprises a spring for pressing said at least one engagement feature against said file drawer to provide an engagement of said device to said file drawer.

16. The device of claim 11, wherein said receptacle forms a divider for files in said file drawer.

17. The device of claim 11 further comprising at least one item organizer for organizing said items within said receptacle.

18. An apparatus for securing objects in a drawer, said apparatus comprising:
a housing for storage of said objects, said housing further for enabling placement of additional objects in said drawer and outside of said housing while said housing is mounted in said drawer;
a lock mechanism for placing said housing in a secured state, wherein access to said objects within said housing is limited when maintained in said secured state; and
at least one engagement feature coupled to said housing and for securing said housing to said drawer when said housing is interposed in said drawer.

19. The apparatus of claim 18 further comprising a door coupled with said housing, wherein said door is operable to close an opening of said housing to limit access to said objects when in said secured state.

20. The apparatus of claim 18, wherein said housing is secured to said drawer by an engagement of said at least one engagement feature with an interior surface of said drawer, and wherein said at least one engagement feature protrudes from said housing to enable said engagement with said drawer.

21. The apparatus of claim 18, wherein said at least one engagement feature is adjustable to enable removal of said housing from said drawer when in an unsecured state.

22. A safe comprising:
a housing shaped to fit within the confines of a desk drawer and comprising an opening for receipt and storage of items within said housing;
a door for closing said opening to restrict access to items within said housing when in a closed state, said door coupled to said housing;
a lock for locking said door when in said closed state; and
a plurality of adjustable elements mounted on at least two sides of said housing, said elements for physically contacting interior sides of said drawer for securing said housing within said drawer.

23. The safe of claim 22, wherein said plurality of elements are not adjustable when said door is closed.
